(19) United States
(12) Patent Application Publication
(10) Pub. No.: US 2024/0013256 A1
(43) Pub. Date: Jan. 11, 2024

(54) INFORMATION PROVIDING APPARATUS, INFORMATION PROVIDING SYSTEM, INFORMATION PROVIDING METHOD, AND NON-TRANSITORY COMPUTER READABLE MEDIUM

(71) Applicant: NEC Corporation, Minato-ku, Tokyo (JP)

(72) Inventors: Akira Hashimoto, Tokyo (JP); Kenichi Ichihara, Tokyo (JP); Toshikazu Maruyama, Tokyo (JP); Shizuko Kanegae, Tokyo (JP)

(73) Assignee: NEC Corporation, Minato-ku, Tokyo (JP)

(21) Appl. No.: 18/025,276

(22) PCT Filed: Sep. 25, 2020
(86) PCT No.: PCT/JP2020/036248

§ 371 Date: Mar. 8, 2023

(51) Int. Cl. G06Q 30/0251; H04W 4/021

(52) U.S. Cl. CPC G06Q 30/0261; H04W 4/021; G06Q 30/0269

(57) ABSTRACT

To make it possible to set an appropriate advertisement spot in accordance with a content service. An information providing apparatus includes a storage unit configured to store position information associated with a position on a route, and content information associated with the position information, and a control unit configured to provide first content information associated with first position information acquired from a user terminal based on the first position information. The control unit sets an advertisement spot having an attribute associated with an attribute of the first content information provided at a first position at a second position on the route, the second position being a predetermined distance apart from the first position.

### TECHNICAL FIELD

The present disclosure relates to an information providing apparatus, an information providing system, an information providing method, and a program.

### BACKGROUND ART

In recent years, as communication apparatuses such as smartphones have become popular, services using position information called a geofence have started to be provided. The geofence is an area enclosed by a virtual fence (a virtual boundary line) provided (i.e., defined) on a map. By setting such a geofence, stores and the like in the geofence can provide information about the stores and the like, such as advertisements and coupons, to user terminals possessed by users who have entered the geofence.

For example, Patent Literature 1 discloses that a management server provides, in response to a supply from a mobile terminal apparatus, event information related to a facility to the mobile terminal apparatus.

### CITATION LIST

### Patent Literature

Patent Literature 1: International Patent Publication No. WO2016/194117

### SUMMARY OF INVENTION

### Technical Problem

In regard to technologies up to now, it, in some cases, is impossible to set an appropriate advertisement spot in accordance with a content service.

The present disclosure has been made to solve the above-described problem, and an object thereof is to provide an information providing apparatus, an information providing system, an information providing method, a program and the like capable of setting an appropriate advertisement spot in accordance with a content service.

### Solution to Problem

An information providing apparatus according to a first aspect of the present disclosure includes:
a storage unit configured to store position information associated with a position on a route, and content information associated with the position information; and
a control unit configured to provide first content information associated with first position information acquired from a user terminal based on the first position information, in which
the control unit sets an advertisement spot having an attribute associated with an attribute of the first content information provided at a first position at a second position on the route, the second position being a predetermined distance apart from the first position.

An information providing system according to a second aspect of the present disclosure includes:
a storage unit configured to store position information associated with a position on a route, and content information associated with the position information; and
a control unit configured to provide first content information associated with first position information acquired from a user terminal based on the first position information, in which
the control unit sets an advertisement spot having an attribute associated with an attribute of the first content information provided at a first position at a second position on the route, the second position being a predetermined distance apart from the first position.

An information providing method according to a third aspect of the present disclosure including setting, based on first position information associated with a position on a route, first content information associated with the first position information, and an attribute of the first content information, an advertisement spot information including an attribute associated with the attribute of the first content information and position information indicating a second position on the route, the second position being a predetermined distance apart from the first position.

A non-transitory computer readable medium according to a fourth aspect of the present disclosure stores a program for causing a computer to set, based on first position information associated with a position on a route, first content information associated with the first position information, and an attribute of the first content information, an advertisement spot information including an attribute associated with the attribute of the first content information and position information indicating a second position on the route, the second position being a predetermined distance apart from the first position.

### Advantageous Effects of Invention

According to the present disclosure, it is possible to provide an information providing apparatus, an information providing system, an information providing method, a program and the like capable of setting an appropriate advertisement spot in accordance with a content service.

### BRIEF DESCRIPTION OF DRAWINGS

FIG. 1 is a schematic diagram for explaining an overview of a content service according to some example embodiments;

FIG. 2 is a block diagram for explaining an example of a configuration of an information providing apparatus according to a first example embodiment;

FIG. 3 is a flowchart showing an information providing method according to the first example embodiment;

FIG. 4 is a schematic diagram for explaining an overview of a content service according to some example embodiments;

FIG. 5 is a block diagram for explaining an example of a configuration of an information providing apparatus according to a second example embodiment;

FIG. 6 is a flowchart showing an information providing method according to the second example embodiment;

FIG. 7 is a schematic diagram showing an overall configuration of an information providing system according to a third example embodiment;

FIG. 8 is a diagram for explaining an example of a configuration of a server according to the third example embodiment;

FIG. 9 is a block diagram showing an example of a configuration of the server according to the third example embodiment;

FIG. 10 shows an example of a hardware configuration of the server according to the third example embodiment;

FIG. 11 is a block diagram showing an example of a configuration of a hearable device according to the third example embodiment;

FIG. 12 is a block diagram showing an example of a configuration of a wearable device according to the third example embodiment;

FIG. 13 is a table for explaining an example of control of contents by the server according to the third example embodiment;

FIG. 14 is a schematic diagram for explaining an overview of control of an audio content service according to the third example embodiment; and

FIG. 15 is a flowchart showing a flow of control of an audio content.

### EXAMPLE EMBODIMENT

### First Example Embodiment

An example embodiment according to the present disclosure will be described hereinafter with reference to the drawings.

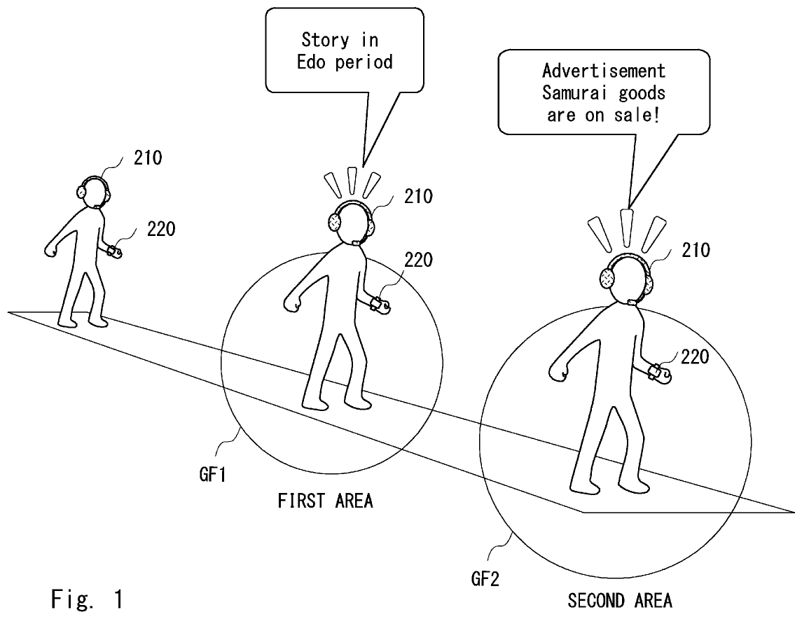

An outline of an information providing apparatus according to an example embodiment will be described with reference to FIG. 1.

Areas enclosed by virtual fences (virtual boundary lines) (also called geofences, and indicated as GF1 and GF2 in FIG. 1) are provided (i.e., defined) on a map. FIG. 1 shows a state in which a user is walking on a route toward a target object (not shown). As shown in FIG. 1, when a user, who possesses a user terminal such as a hearable device 210 or a wearable device 220, enters this first area GF1, a first content is provided from the information providing apparatus to the user terminal. This first content may be an audio content such as a sightseeing guide, or may be a content service in which visual AR (Augmented Reality) and an audio AR are fused (i.e., mixed), such as a content service in which a statue, a mascot doll, a signboard, and/or a poster in the street are personified and talk to users.

A geofence is usually provided (i.e., set) before a target object (i.e., between the current position of the user (e.g., a tourist) and the target object). The target object is not limited to buildings, facilities, and shops, but can also include various objects such as signs, signboards, mannequins, mascot dolls, animals, fireworks, and the like. In such a system, a content provider may assume (e.g., predict) a route to the target object and can set (i.e., define) a geofence(s) on the assumed route. The route to the target object is a route along which pedestrians move (e.g., walk) to reach the target object, and is not limited to a route for which the estimated arrival time thereat is the shortest. That is, the route can include various routes along which pedestrians could move.

In this way, a content provider (including an advertiser) in such a system can, to some extent, predict the emotions of users who have viewed the first content and the direction in which they walk. Specifically, the content provider has analyzed the emotional states of users and a landscape at each point that the users will pass through during the time the content service is being provided in advance, so that it is possible to arouse strong willingness in the users to buy a product or the like by putting an advertisement(s) that matches the emotions of the users and the landscape at that point. The first content includes guide information for guiding users regarding the direction in which they should move, a route to the target object, a story associated with a building or scenery in or near the area the users are in, and the like.

In this example embodiment, the information providing apparatus also sets an advertisement spot for providing, when a user, whose emotion or moving direction can be predicted as described above, reaches the second area GF2, a second content (an advertisement) associated with an attribute of the first content (or a second content (an advertisement) having the same attribute as that of the first content) to his/her user terminal. That is, the information providing apparatus sets an advertisement spot for providing an advertisement at an appropriate position on the route. The second content can be mainly advertisement information having the same attribute as that of the first content, but is not limited to this example. The second content may be partially composed of advertisement information. The second content (the advertisement) associated with the attribute of the first content does not necessarily have to have the same attribute as that of the first content. For example, the content provider (e.g., the advertiser) can associate the attribute of the second content with that of the first content in an arbitrary manner. The information providing apparatus stores (i.e., holds) attributes of contents with which an advertising effect that is set by the content provider in advance can be expected. Therefore, the information providing apparatus can specify, from the attributes of the first content, an attribute(s) related to an attribute(s) of the first content with which an advertising effect can be expected. For example, when the first content is one for introducing, to a user, a castle in front of the user, the first content may be assigned attributes such as “history” and “majesty.”

In this case, examples of conceivable second contents associated with the first content include an advertisement for a whiskey “How about a glass of whiskey at the foot of the magnificent mountain range” or an advertisement for a period drama (“A historical drama concerning this castle will start next spring”). The second content may be an audio content or information such as an email or a message. The provider of the first content and the provider of the second content (e.g., the advertiser) may be the same as each other or different from each other. In this specification, the advertisement information means information about a product, a service, a company profile, or the like that the advertiser conveys to certain people in order to achieve an advertising goal. The advertisement spot is, in such a system, a spot (e.g., an area) in which such an advertisement is provided, and is an area in which a content associated with position information is provided. The attribute information is information indicating an attribute(s) of a content.

The first and second areas GF1 and GF2 may be mutually exclusive as shown in FIG. 1, or may partially overlap each other. That is, the second content can be provided while the first content is being provided, or after the first content is provided.

In the above-described example, the first area GF1 is set as an area where a content service is provided and the second area GF2 is set as an area where an advertisement or an advertisement spot is provided, but they may be the other way around. That is, the first area GF1 may be set as an area where an advertisement or an advertisement spot is provided, and the second area GF2 may be set as an area where a content service is provided. The advertisement spot may be set before a content service (i.e., between the current position of the user (e.g., a tourist) and the content service).

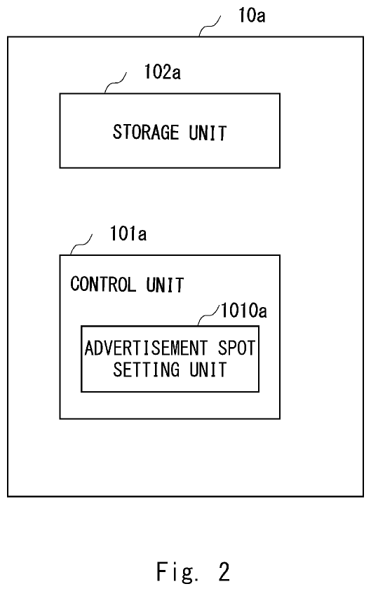

FIG. 2 is a block diagram for explaining an example of a configuration of an information providing apparatus according to a first example embodiment.

The information providing apparatus 10a may be a server implemented by a computer. The information providing apparatus 10a includes a storage unit 102a that stores position information associated with a position on a route, and content information associated with the position information, and a control unit 101a that provides first content information associated with first position information acquired from a user terminal based on the first position information. The control unit 101a includes an advertisement spot setting unit 1010a. The advertisement spot setting unit 1010a sets an advertisement spot having an attribute associated with an attribute of the first content information provided at a first position at a second position on the route, which is a predetermined distance apart from the first position.

The advertisement spot information in this specification may include at least one position information and at least one attribute information. That is, the advertisement spot information may include a plurality of (i.e., a plurality of pieces of) position information in accordance with buildings, landscapes, and the like on the route. Further, the advertisement spot information can include a plurality of (i.e., a plurality of pieces of) attribute information associated with attributes of the first content information with which an advertising effect can be expected. In this way, an advertiser can determine whether or not to provide an advertisement based on a plurality of attributes and a plurality of (i.e., a plurality of pieces of) location information. The advertisement spot information may be included, by the information providing apparatus 10a, in an email, a message, or the like, and provided (e.g., provided in the form of an email, a message, or the like) to a potential advertiser(s). Further, the advertisement spot information may be output, by the information providing apparatus 10a, to a Web server that operates and manages an auction site or the like in order to invite advertisers who will put advertisements in the auction site or the like.

The control unit 101a can output the first content information to the user terminal based on the position information acquired from the user terminal. In this case, the first content information may include delivery position information (including geofence information) of the first content and at least one attribute of the first content. Further, the control unit 101a can set, based on the delivery position information of the first content information and the attribute information of the first content information, an advertisement spot having an attribute with which an advertising effect can be expected along with appropriate delivery position information. The appropriate delivery position information can be set on the route to the target object. For example, an advertisement spot may be set at a position on the route that is a predetermined distance apart from the area where the content service is provided. Further, an advertisement spot may be set between two (i.e., two pieces of) content information delivered at different positions on the route. The advertisement spot information includes delivery position information of a second content, which is different from the delivery position information of the first content, and an attribute(s) that is the same as or associated with the attribute(s) of the first content.

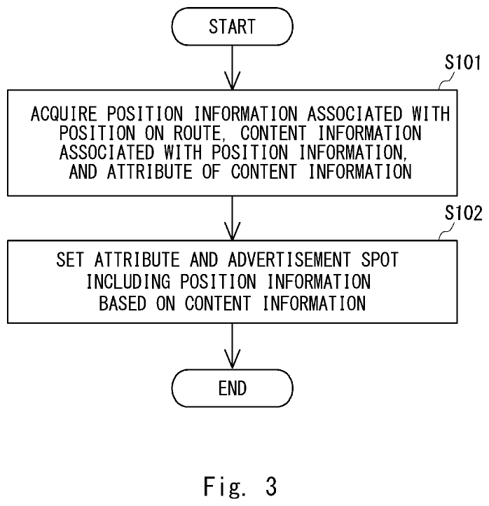

FIG. 3 is a flowchart showing an information providing method according to the first example embodiment.

First position information associated with a position on a route, first content information associated with the first position information, and an attribute(s) of the first content information are acquired (Step S101). Based on the first position information associated with the position on the route, the first content information associated with the first position information, and the attribute of the first content information, advertisement spot information including an attribute(s) associated with the attribute(s) of the first content information and position information indicating a second position on the route, which is a predetermined distance apart from the first position are set (Step S102).

According to the above-described example embodiment, it is possible to set an appropriate advertisement spot in accordance with a content service. Further, it is possible to predict the emotion of a user and the direction in which the user will move by providing the content service, so that it is possible to set an appropriate advertisement spot for the user whose emotion and moving direction have been predicted.

### Second Example Embodiment

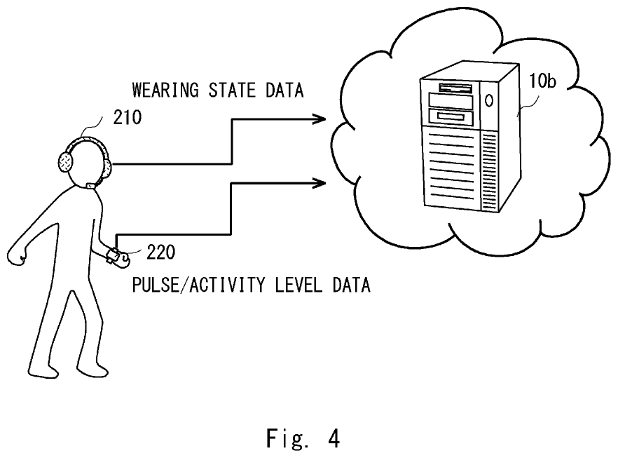

An outline of an information providing apparatus according to a second example embodiment will be described with reference to FIG. 4.

In the second example embodiment, at least one user is made to walk on a route on a trial basis before an advertisement spot(s) is set. When doing so, the information providing apparatus acquires information (e.g., biometric information and line-of-sight information) from a user terminal(s) possessed by the user(s) and, an attribute(s) of an ordinary user(s) who walks along the route is specified based on the acquired information. After that, the information providing apparatus sets an advertisement spot having an attribute associated with the specified attribute of the ordinary user based on this attribute. In this way, it is possible to set an advertisement spot with which a larger advertising effect can be expected.

Specifically, based on the biometric information of the user acquired from the user terminal (the wearable device 220 in this example), the emotion of the user, to which the first content has been provided, is analyzed, and based on the result of the emotional analysis, the attribute (e.g., an attribute related to the emotion (excitement, elation, or the like)) of the first content is specified. Further, it is possible set an advertisement spot having an attribute associated with the specified attribute of the first content. Examples of the user terminal may include a wearable device, a hearable device, a smartwatch, and any combination thereof. The wearable device 220 is, for example, a smartwatch, and can acquire a pulse rate and an activity level of the user. Further, the hearable device 210 is, for example, a headset-type device, and can acquire the direction of the line of sight or the orientation of the face of the user. Such information is collected by a server (an information providing apparatus) 10b, and the emotion of the user is analyzed based thereon. The server specifies the attribute of the first content as a result of the emotional analysis, and can determine the attribute of the second content based on the specified attribute of the first content. Specifically, the server can determine average emotional attributes according to the profiles of users (e.g., ages, genders, races, lifestyles, and the like) by analyzing the emotions of a large number of users based on biometric information of the large number of users obtained from a large number of user terminals (wearable devices in this example).

Further, the server analyzes the lines of sights of a large number of users based on line-of-sight information of the large number of users obtained from a large number of user terminals (hearable devices in this example), and specifies the lined of sights of the users at a specific position. Further, the server can set an advertisement spot having an attribute associated with the specified line of sight of the user. For example, when it can be determined that a large number of users view a certain building (e.g., a museum) at a specific position, the server may set an advertisement spot having an attribute associated with the specified line of sight of the user, i.e., an attribute of this building.

The result of the line-of-sight analysis based on the line-of-sight information may be taken into consideration in the above-described emotional analysis. Alternatively, the result of the emotional analysis based on the biometric information may be taken into consideration in the line-of-sight analysis.

Note that although the server (the information providing apparatus) 10 acquires biometric information such as a pulse rate and an activity level of the user and performs the emotional analysis in the above-described example, the user terminal may perform such an emotional analysis. Alternatively, the user terminal may analyze the line of sight of the user based on the direction of the line of sight or the orientation of the face of the user. In this case, the server may acquire the result of the emotional analysis and the line-of-sight information of the user for the first content from the user terminal.

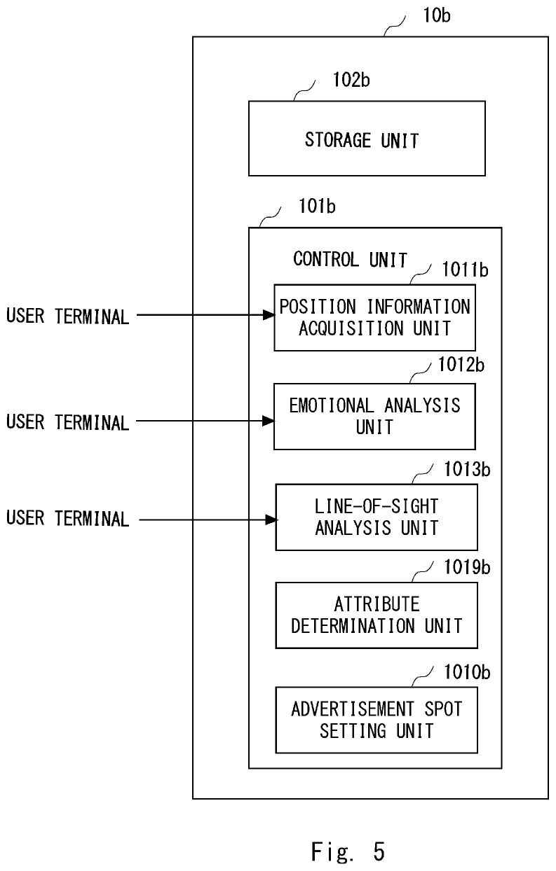

FIG. 5 is a block diagram for explaining an example of a configuration of an information providing apparatus according to the second example embodiment.

The information providing apparatus 10b may be a server implemented by a computer. The information providing apparatus 10b includes a storage unit 102b that stores position information associated with a position on a route, and content information associated with the position information, and a control unit 101b that provides first content information associated with the first position information acquired from a user terminal based on the first position information. The control unit 101b includes a position information acquisition unit 1011b, an emotional analysis unit 1012b, a line-of-sight analysis unit 1013b, an attribute determination unit 1019b, and an advertisement spot setting unit 1010b. The position information acquisition unit 1011b acquires position information from a user terminal through a network. After the emotional analysis unit 1012b provides first content information, it analyzes the emotion of at least one user based on biometric information of the user acquired from at least one user terminal (a wearable device in this example) through the network. Further, the attribute determination unit 1019b specifies an attribute of a first content at a specific position based on the position information of the user and the result of the emotional analysis. The advertisement spot setting unit 1010b sets an advertisement spot having an attribute associated with the specified attribute of the first content at the specific position.

The line-of-sight analysis unit 1013b analyzes the line of sight of at least one user based on position information and line-of-sight information acquired from at least one user terminal. For example, when a user proceeds on the route, the line-of-sight analysis unit 1012b may analyze the line of sight of the user at a specific position on the route. Further, for example, after the emotional analysis unit 1012b provides the first content information, it may analyze the line of sight of at least one user based on position information and line-of-sight information acquired from at least one user terminal through the network. Further, the attribute determination unit 1019b specifies the line of sight of the user at the specific position based on the result of the above-described line-of-sight analysis, and determines the attribute associated with the specified line of sight of the user. The advertisement spot setting unit 1010b sets an advertisement spot having an attribute associated with the line of sight of the user at the specific position.

The user terminal is a portable terminal possessed by the user and can be, for example, a hearable device, a wearable device, or other suitable user devices.

The attribute associated with the line of sight of the user can be an attribute associated with an object such as a building or scenery at which the lines of sights of a large number of users are attracted at a specific position.

Further, after the advertisement spot is set, dynamic control of the content may be performed after an advertisement for the advertisement spot is actually determined. That is, the information providing apparatus may control the output of the advertisement based on interest information (i.e., information about the interest) of the user for the first content.

The interest information of the user for the first content is determined based on biometric information of the user or posture information (i.e., information about the posture) (e.g., the line of sight or the orientation of the face) of the user acquired by the user terminal. The interest information is information including an interest score indicating a possibility that the user is interested in the content. The interest score is calculated based on, for example, parameters for identification learned in advance and feature values related to the biometric information of the user. Such identification parameters can be generated, for example, by performing machine learning by using feature values of biological information that is acquired when the user is having an interest and feature values of biological information that is acquired when the user is having no interest. The interest score means an indicator as to how much the user has interest as compared to the normal state (the uninterested state). The interest score can be expressed, for example, as a numerical value no smaller than zero and no larger than one. In this case, for example, the closer the interest score is to one, the higher the probability that the user has an interest is. Conversely, the closer the interest score is to zero, the higher the probability that the user has no interest is.

The interest information can include information indicating the type, degree, and presence/absence of the interest. Examples of the type of the interest include various emotions such as delight, anger, sorrow, pleasure, excitement, elation, accomplishment, and an excited feeling. The degree may be specified by a level (a numerical value) indicating the degree of strength for the type. The presence/absence of the interest can indicate whether or not the user is interested in the content depending on whether the interest score exceeds an arbitrarily determined threshold.

The control unit 102b may control the output of a second content based on the interest information for the first content acquired from the user terminal that has acquired the first content information. “Controlling the output of the second content” may include stopping the output of the second content, changing the second content (i.e., a change to a content having a different attribute), changing the delivery position of the second content, changing the delivery time, and the like. For example, when the interest of the user in the content is low, the output of the second content can be stopped. When the interest of the user in the content is low, the content can be changed to a content having a different attribute. Further, when the interest of the user in the content is low, the advertisement may be changed to an advertisement of which the duration is shorter than that of ordinary advertisements. “Controlling the output of the second content” may include various other suitable forms.

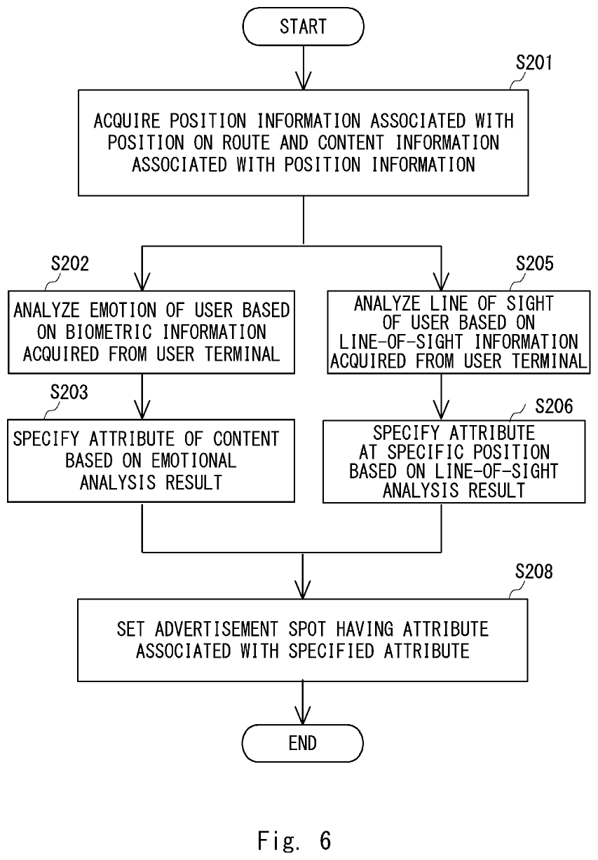

FIG. 6 is a flowchart showing an information providing method according to the second example embodiment.

First position information associated with a position on a route and first content information associated with the first position information are acquired (Step S201). The emotion of the user is analyzed based on biometric information acquired from a user terminal (e.g., a wearable device) (Step S202). An attribute(s) of a first content (e.g., an attribute related to the emotion) is specified based on the result of the emotional analysis (Step S203). Alternatively, the line of sight of the user is analyzed based on line-of-sight information acquired from a user terminal (e.g., a hearable device) (Step S205). In the line-of-sight analysis of the user, for example, objects (e.g., buildings, scenery, signboards, mascot dolls, and the like) at which the lines of sights of a large number of users are attracted are specified at various positions on the route. An attribute(s) at a specific position is specified based on the result of the line-of-sight analysis (Step S206). For example, an attribute(s) for an object at a specific position is specified. An advertisement spot having an attribute associated with the attribute specified as described above is set (Step S208).

In the above-described example embodiment, by analyzing the emotion of a user to which a content has been provided, it is possible to specify an attribute(s) of the user for the content and thereby appropriately set the subsequent advertisement spot. Further, by analyzing the line of sight of a user at various positions on the route, it is possible to specify an attribute(s) associated with the line of sight of the user at a specific position and thereby appropriately set the subsequent advertisement spot.

### Third Example Embodiment

An outline of an audio content service according to a third example embodiment will be described.

In this example, it is assumed that a user walks around a town, an event space, or the like while wearing a user terminal such as a hearable device or a wearable device. At least one geofence is disposed (i.e., defined) at a predetermined place. When the user enters the geofence, various audio contents (e.g., a sightseeing guide) are played back through the user terminal. In this example embodiment, a system that plays back an audio content for a user present in a specific area by using a highly-accurate geofence and an acoustic localization technology is used. The system may also be called an SSMR (Space Sound Mixed Reality) service. Such an audio content may be a guide service (also called a content service) in which “visual AR” and “acoustic AR” are fused (i.e., mixed). In such an SSMR system, an audio advertisement spot is provided to an advertiser. The advertiser can deliver (or distribute) its own audio advertisement that fits the audio content service in such an SSMR system.

From the past, advertisement spots have been provided on moving image distribution platforms and other various platforms such as television and radio. For example, advertisements are provided between programs (contents) in television and radio. However, with conventional advertisement spots, advertises have not been able to satisfactorily approach viewers/listeners of contents. In particular, they have not been able to satisfactorily approach the emotional sides of users that are affected by the development of the content. Therefore, the present disclosure provides a system that efficiently provides an advertisement according to the emotion or the degree of interest of a user.

Specifically, in the SSMR system, it is possible to predict, to some extent, the emotion of the user and the direction in which the user will walk based on the scenario of the content. Further, the emotional state of a user and a landscape at each point that the user will visit during a content service have been determined (e.g., predicted) in advance, so that it is possible to arouse strong willingness to buy a product or the like by putting an advertisement that match the emotion and the landscape at that point. In this system, it is possible to define a new advertisement spot different from conventional advertisement spots. Further, the use of MEC (Multi-access Edge Computing) makes it easier to switch the content of the SSMR service, and an audio advertisement that fits the weather of the day, the time period, and the attribute of the user (e.g., a gender and an age group) is delivered. In this way, it becomes possible to realize a mechanism to arouse willingness to buy a product or the like even further. Further, in the present disclosure, as shown in FIG. 4, the delivery of an advertisement is controlled based on the interest information for the content acquired from the user wearing a hearable device, a wearable device, or the like. As the interest information, the line of sight and the posture of the user can be detected by using a nine-axis sensor provided inside the hearable device. Further, as the interest information, data such as a pulse rate and an activity level can be acquired by using the wearable device. The server collects the interest information of the user and makes it possible to deliver an appropriate advertisement based on the interest information.

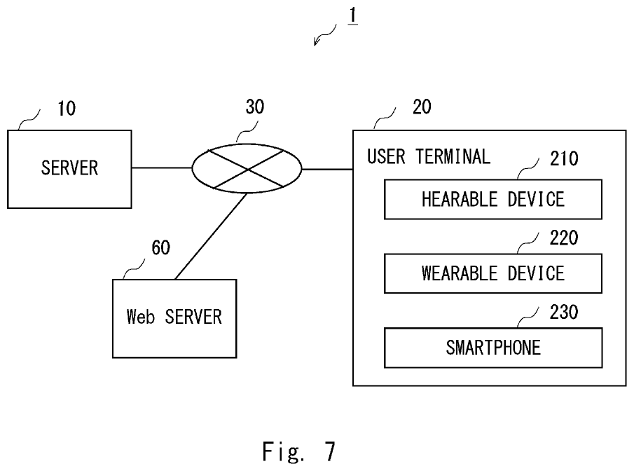

FIG. 7 is a diagram for explaining an overall configuration of an information providing system.

An information providing system 1 includes a server 10 (also called an information providing apparatus) and a user terminal 20 connected to the server through a wired or wireless network 30. Further, the information providing system 1 may also include a Web server 60 connected through the network 30. The network 30 may include a local area network (LAN) and a wide area network (WAN), for example, the Internet or a mobile communication network. The server 10 is an example of the information providing apparatus according to the first or second example embodiment. The user terminal 20 may include a hearable device 210, a wearable device 220, and a smartphone 230. The user terminal 20 is not limited to these devices and may be a part of these devices (e.g., is composed of a hearable device or a wearable device alone). Alternatively, other suitable devices may be used.

The server 10 provides, for example, information about a specific target object on a map, a facility, a store, and the like (e.g., information about an event or the like), and/or a guide service (a content service) in which “visual AR” and “acoustic AR” are fused to a user terminal possessed by a user who has entered the geofence. These target object and the like are associated with the geofence which has been set (e.g., defined) in advance. In this specification, the geofence may also be simply called as an area.

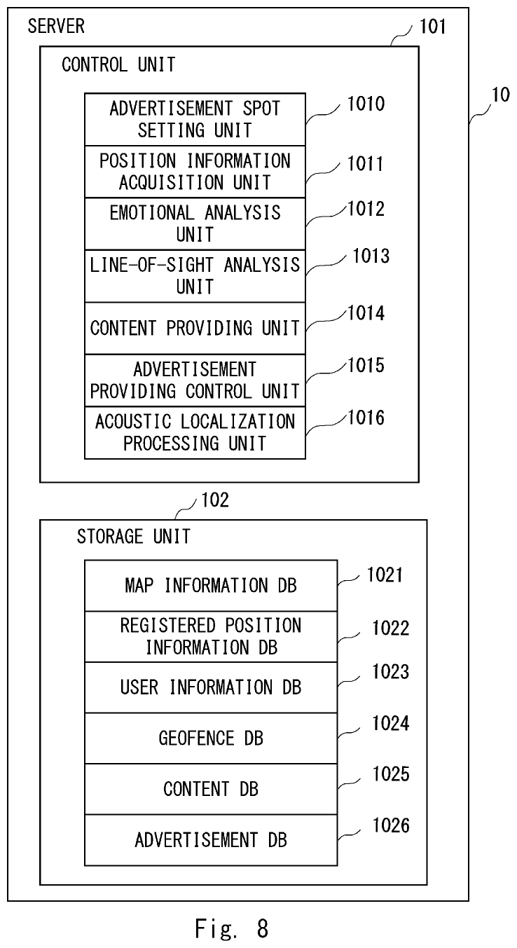

FIG. 8 shows an example of a configuration of a server.

The server 10 is a computer including a control unit 101 and a storage unit 102. The control unit 101 includes a processor such as a CPU (Central Processing Unit). The control unit 101 includes an advertisement spot setting unit 1010, a position information acquisition unit 1011, an emotional analysis unit 1012, a line-of-sight analysis unit 1013, a content providing unit 1014, an advertisement provision control unit 1015, and an acoustic localization processing unit 1016. Note that the server 10 may be disposed on a cloud side through a mobile network and the Internet, or on a base-station side through a mobile network such as 5G using MEC (Multi-access Edge Computing).

The advertisement spot setting unit 1010 acquires position information associated with a position on a route, and content information associated with the position information from the storage unit 102, and sets an advertisement spot having an attribute associated with an attribute of the content information at a predetermined position on the route. Further, the advertisement spot setting unit 1010 can also determine an attribute of an advertisement spot based on the result of the analyses by the emotional analysis unit 1012 and the line-of-sight analysis unit 1013 (which will be described later). Further, the advertisement spot setting unit 1010 may also output advertisement spot information including the determined position information and having the determined attribute to the Web server 60, and put an advertisement in an auction site for inviting advertisers for the advertisement spot.

The position information acquisition unit 1011 acquires position information of a user terminal through the network. The emotional analysis unit 1012 acquires biometric information and posture information (the direction of the line of sight or the orientation of the face) of the user from the user terminal 20, and thereby analyzes the emotion of the user. Further, the emotional analysis unit 1012 can also determine an emotional attribute(s) (e.g., excitement, elation, and the like). The line-of-sight analysis unit 1013 acquires line-of-sight information of a user from at least one user terminal 20, and thereby analyzes the line-of-sight of the user. The line-of-sight analysis unit 1013 can specify an object(s) at which the lines of sights of a large number of users are attracted from line-of-sight information of users as well as from information from a map information database 1021 and a registered position information database 1022 stored in the storage unit 102. As the result of the line-of-sight analysis, an attribute(s) associated with the line of sight of the user at a specific position, i.e., an attribute(s) of the object(s) at which the lines of sights of a large number of users are attracted are obtained. Note that the emotional analysis unit 1012 and the line-of-sight analysis unit 1013 can also analyze the interest information of the user for the first content even after providing the first content to the user in order to dynamically control the second content.

The content providing unit 1014 delivers (or distributes) a content to the user terminal 20 through the network. The content providing unit 1014 can appropriately deliver the content based on a content ID and a user terminal ID. The content may be an audio content, or may be a combination of an audio content and a visual content.

The advertisement provision control unit 1015 delivers (or distributes) an advertisement to the user terminal 20 through the network. Further, the advertisement provision control unit 1015 can also control how to provide an advertisement to the user terminal 20 based on the interest information of the user. Based on the interest information, the advertisement provision control unit 1015 can deliver an advertisement having the same attribute as that of the content as described above or an attribute different from that of the content. Further, the advertisement provision control unit 1015 may also change a delivery position or a delivery time based on the interest information.

The acoustic localization processing unit 1016 performs sound-image localization processing on the audio content to be output according to the position of the target object and the posture information of the user (i.e., the orientation of the user terminal). The sound-image localization processing performed in the acoustic AR is to generate, as right-ear sound information and left-ear sound information, two pieces of sound information of which sound images are localized at the position of the virtual sound source. As the user listens to these (two pieces of) audio information, he/she can experience a virtual emotion as is he/she is listening the sound from the position of the virtual sound source. In the sound-image localization, the distance from the virtual sound source and the direction to the user with respect to the virtual sound source are acquired, and sound-image localization processing is performed for the sound content based on the acquired information. The distance between the virtual sound source and the user can be calculated based on the latitude/longitude information of the position of the virtual sound source and that of the position of the user. The direction to the user with respect to the virtual sound source can be calculated based on the movement angle and the position information of the virtual sound source. The position of the virtual sound source may be the same as the target-object position information indicating the position of the target object. Further, in the case where the user experiences the sensation of hearing a speech from the target object located near him/her or a speech from a virtual girlfriend/boyfriend, the position of the virtual sound source may be a position corresponding to an object or a virtual object provided near the user. In this way, the user can hear audio information, of which the sound image has been localized, according to the orientation of the head of the user when the user enters the geofence. Therefore, even when the angle at which the user enters the geofence varies within a range of the angle-of-entry threshold, the user can hear the sound as the audio information from the predetermined position.

The storage unit 102 includes a map information database 1021, a registered position information database 1022, a user information database 1023, a geofence database 1024, a content database 1025, and an advertisement database 1026.

The map information database 1021 may contain information about a road network including roadways, sidewalks and the like, junctions including intersections, T-intersections, and the like, traffic signals, traffic signs, various buildings, various facilities, and the like.

The registered position information database 1022 stores (i.e., contains), for example, information about registered target objects such as shops, buildings, museums, cinemas, archaeological sites, and sightseeing spots. Further, the registered position information database 1022 can store (i.e., contain) position information of various objects such as signs, signboards, mannequins, mascot dolls, animals, fireworks, and the like. By having a staff of a facility register such information in the information providing system 1 in advance, such information can be provided to the user terminal 20 of a user who has entered the geofence associated with the facility. Content data in which information related to the registered position information is fused with visual AR and/or acoustic AR may be provided to the user terminal 20.

The user information database 1023 may include information about users (user identification information) who want to receive content information through their user terminals 20, such as user IDs, passwords, terminal IDs, ages, genders, hobbies, and preferences of users. Further, the user information database 1023 can include information about target objects such as various objects including stores from which users want to receive information, buildings, museums, cinemas, archaeological sites, sightseeing spots, signs, signboards, mannequins, mascot dolls, animals, fireworks, and the like. The user ID is an identifier by which the user is uniquely identified. The terminal ID is an identifier by which the terminal is uniquely identified.

The geofence database 1024 can include, in association with the above-described registered position information, the geofence ID, latitude, longitude, range, size, angle-of-entry threshold, and angle-of-exit threshold of the set geofence. The geofence ID is an identifier by which the geofence is uniquely identified. The geofence can include an area(s) for a content and an area(s) for delivering an advertisement.

The content database 1025 may include content information associated with the geofence ID for the content and the user ID. The content information may be a content including acoustic AR having a predetermined play-back time, or content data having a predetermined play-back time in which visual AR and acoustic AR are fused. The length, i.e., the predetermined play-back time, of such a content can be arbitrarily set while taking the walking speed of the user, the distance between the geofence and the store, and the like into consideration.

Further, the advertisement database 1026 stores (i.e., contains) various types of advertisements associated with the geofence ID for advertisement delivery and the user ID and associated with the attributes of the respective contents (also called as audio contents corresponding to specific attributes), and their advertisements ID. The advertisement ID is an identifier by which the advertisement is uniquely identified. Further, the advertisement database 1026 stores (i.e., contains) various types of advertisements associated with the geofence ID for advertisement delivery and the user ID but not associated with the attributes of the respective contents (also called as audio contents not corresponding to specific attributes), and their advertisements ID. The advertisement database 1026 can also store (i.e., contain) a plurality of advertisements (i.e., audio contents corresponding to specific attributes and audio contents not corresponding to specific attributes) for one content. The advertisement database 1026 can also store (i.e., contain) advertisement spot IDs and advertisement spot information. The advertisement spot information includes delivery position information and an attribute(s) regardless of whether there is an advertisement content or not.

Note that although the storage unit 102 is disposed inside the server 10 in the above-described example, the storage unit 102 may be disposed outside the server 10. In that case, when the storage unit 102 is disposed inside the information providing system, the present disclosure can be carried out by a server that is connected to the storage unit disposed outside the server 10 through a network.

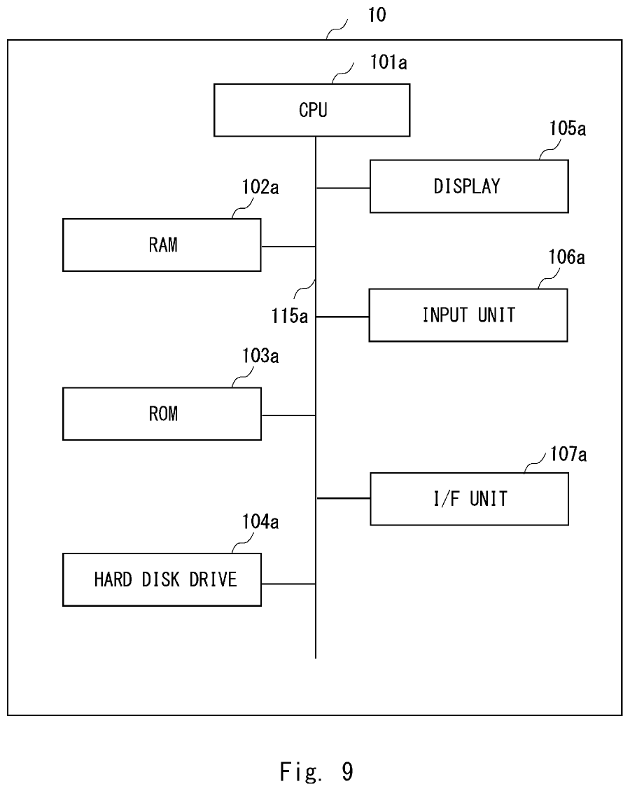

FIG. 9 is a block diagram showing an example of a hardware configuration of the server 10 in this example embodiment. As shown in FIG. 7, the server 10 is a computer (an information processor) including a CPU 101a, a RAM 102a, a ROM 103a, and the like. The CPU 101a performs calculation and control according to software stored in the RAM 102a or the ROM 103a, or in a hard disk drive 104a. The RAM 102a is used as a temporary storage area when the CPU 101a performs various processes. In the hard disk drive 104a, an operating system (OS), a registration program, and the like are stored. A display 105a is composed of a liquid-crystal display and a graphic controller, and objects such as images and icons, and GUIs are displayed on the display 105a. An input unit 106a is a device by which a user gives various instructions to the server 10, and composed of, for example, buttons, a keyboard, an on-screen keyboard, a mouse, and the like. An I/F (InterFace) unit 107a can control wireless or wired LAN communication in conformity with IEEE 802.11a or the like, and communicate with external apparatuses through the same communication network or the Internet in accordance with a protocol such as TCP/IP. A system bus 115a controls transmission/reception of data to/from the CPU 101a, the RAM 102a, the ROM 103a, and the hard disk drive 104a.

The user terminal 20 can be, for example, a computer that a user walking on the street can carry, such as a smartphone, a wearable device, a smartphone watch, or a hearable device.

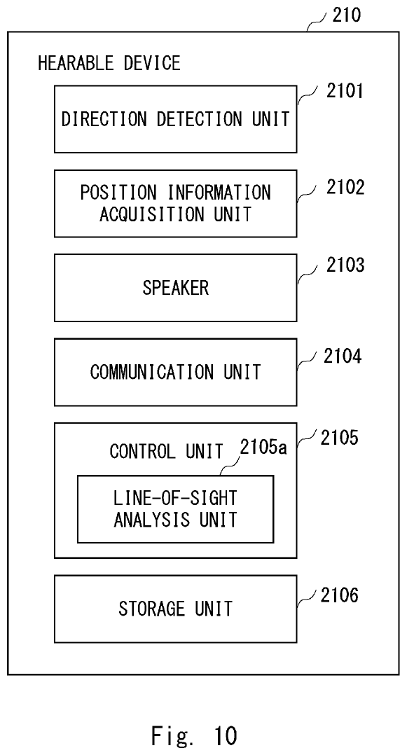

FIG. 10 is a block diagram showing a configuration of a hearable device.

The hearable device 210 can be a headset by which a user listens to an audio content provided from the server. The hearable device 210 can detect the direction of the line of sight of the user wearing it in order to achieve a highly-precise acoustic localization technology. The hearable device may be a type of device that covers both ears of a user, or a bone-conducting type that does not cover both ears of a user.

The hearable device 210 includes a direction detection unit 2101, a position information acquisition unit 2102, a speaker 2103, a communication unit 2104, a control unit 2105, and a storage unit 2106. Further, the hearable device 210 may include a microphone that collects voices of a user and/or ambient sounds (not shown).

The direction detection unit 2101 includes a nine-axis sensor(s) including a three-axis accelerometer, a three-axis gyroscopic sensor, a three-axis compass sensor, and the like for acquiring the direction of the hearable device (i.e., the orientation of the face or the direction of the line of sight of the user). In this way, it is possible to accurately acquire the orientation of the face or the direction of the line of sight of the user.

The position information acquisition unit 2102 includes a GPS (Global Positioning System) receiver, which can detect the current position of the hearable device on the earth and the current time by receiving radio waves transmitted from satellites. Note that position information acquisition unit does not have to be disposed inside the hearable device 210. In that case, a position information acquisition unit 2302 of the smartphone (which will be described later) can be used.

The speaker 2103 can play back an audio content provided from the server and enables a user to listen to the audio content.

The communication unit 2104 is a communication interface with the network 30. The communication unit 2104 is used to communicate with other network node apparatuses included in the information providing system. The communication unit 2104 may be used to perform radio communication. For example, the communication unit 2104 may be used to perform wireless LAN communication specified in IEEE 802.11 series, or mobile communication specified in 3GPP (3rd Generation Partnership Project) or the like. Further, the communication unit 2104 can also connect to a smartphone or a wearable device through Bluetooth (Registered Trademark) or the like so that they can communicate with each other. The communication unit 2104 can transmit line-of-sight information to the server 10.

The control unit 2105 is composed of a processor, a memory, and the like, and performs various processes of the hearable device by loading software (a computer program) from the storage unit 2106 onto a memory and executing the loaded software. Further, the control unit 2105 controls hardware included in the hearable device 210. The processor may be, for example, a microprocessor, an MPU (Micro Processing Unit), or a CPU (Central Processing Unit). The processor may include a plurality of processors.

The control unit 2105 includes a line-of-sight analysis unit 2105a that analyzes the line of sight of the user based on the orientation of the face, the direction of the line-of-sight, or the like of the user acquired by the direction detection unit 2102. The control unit 2105 can also identify interest information for the audio content provided from the server based on the orientation of the face, the direction of the line-of-sight, or the like of the user acquired by the direction detection unit 2102. For example, when the face of the user is facing downward, an interest information identification unit 2105a can determine that the user is less interested in the audio content. Alternatively, in the case where the sound image is localized for the target object as if the target object speaks to the user as described above, it is possible to determine that the user is less interested in the audio content when the user is facing in a direction different from the direction toward the target object.

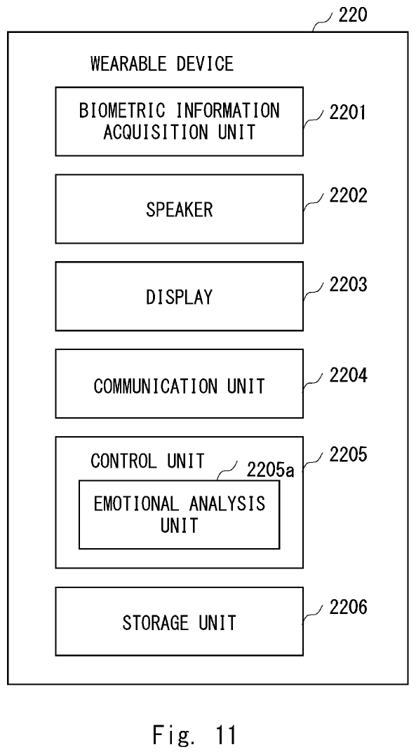

FIG. 11 is a block diagram showing a configuration of a wearable device.

The wearable device 220 may be, for example, but not limited to, a smartwatch. That is, the wearable device 220 may be any of various other types of wearable devices that can be used to acquire biometric information, such as a pulse rate and an activity level, of the user in real time.

The wearable device 220 includes a biometric information acquisition unit 2201, a speaker 2202, a display 2203, a communication unit 2204, a control unit 2205, and a storage unit 2206. The control unit 2205 can include an emotional analysis unit 2205a.

The biometric information acquisition unit 2201 can acquire biometric information of a user who is wearing the wearable device 220. The biometric information means information about a living body that can be measured by a sensor or the like. Specifically, examples of the biometric information include, but are not limited to, a heart rate (a pulse rate), respiration, a blood pressure, a core temperature, a consciousness level, a skin temperature, a skin conductance response (Galvanic Skin Response (GSR)), a skin potential, a myoelectric potential, an electrocardiogram waveform, an electroencephalogram waveform, an amount of sweat, a blood oxygen saturation level, a pulse waveform, optical brain function mapping (Near-infrared Spectroscopy (NIRS)), and a pupil reflection.

The biometric information acquisition unit 2201 may include a speaker 2202 for alerting a user by a sound (or a voice) and a display 2203 for displaying a content to the user.

The communication unit 2204 is a communication interface with the network 30. The communication unit 2204 is used to communicate with other network node apparatuses included in the information providing system. The communication unit 2204 may be used to perform radio communication. For example, the communication unit 2204 may be used to perform wireless LAN communication specified in IEEE 802.11 series, or mobile communication specified in 3GPP (3rd Generation Partnership Project) or the like. Further, the communication unit 2204 can also connect to a smartphone or a hearable device through Bluetooth (Registered Trademark) or the like so that they can communicate with each other. The communication unit 2204 can transmit biometric information to the server 10.

The control unit 2205 is composed of a processor, a memory, and the like, and performs various processes of the hearable device by loading software (a computer program) from the storage unit 2206 onto a memory and executing the loaded software. Further, the control unit 2205 controls hardware included in the hearable device 210. The processor may be, for example, a microprocessor, an MPU (Micro Processing Unit), or a CPU (Central Processing Unit). The processor may include a plurality of processors.

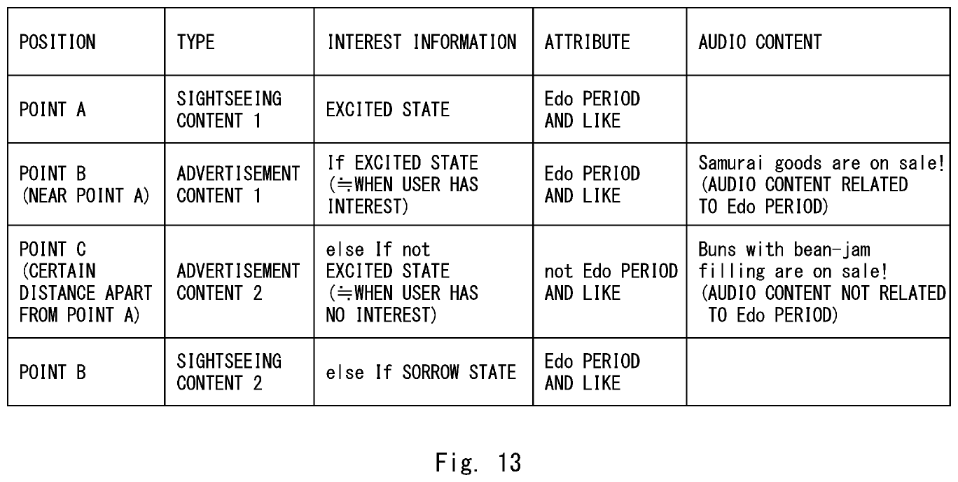

The control unit 2205 includes an emotional analysis unit 2205a that analyzes the emotion of a user for an audio content provided from the server based on the acquired biometric information. The emotional analysis unit 2205a can specify an emotional attribute(s). Further, the control unit 2205 can also identify interest information for the audio content provided from the server based on the acquired biometric information. The interest information will be described later with reference to FIG. 13.

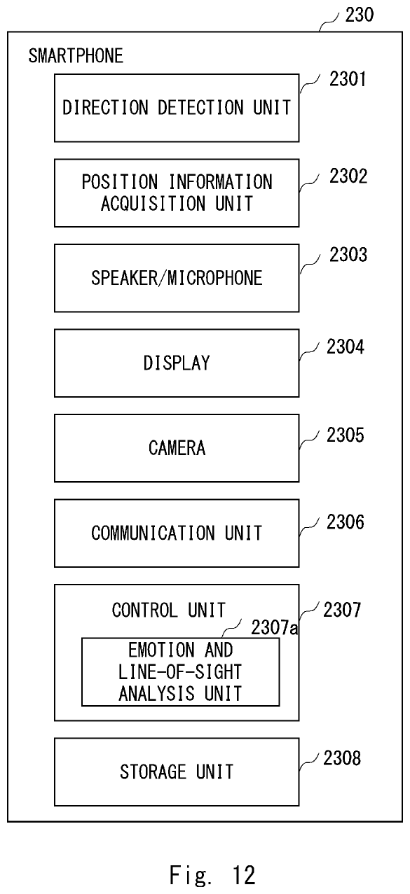

FIG. 12 is a block diagram showing a configuration of s smartphone.

The smartphone 230 can be used to view and listen to an audio content and a visual content provided from the server. Further, the smartphone 230 can be used to detect the orientation of the user and acquire the position of the user. Further, the smartphone 230 may also be configured so as to acquire the direction of the line of sight of the user from the hearable device 210 and thereby identify interest information. Further, the smartphone 230 may be configured so as to acquire biometric information from the wearable device and thereby identify interest information.

The smartphone 230 includes a direction detection unit 2301, a position information acquisition unit 2302, a speaker/microphone 2303, a display 2304, a camera 2305, a communication unit 2306, a control unit 2307, and a storage unit 2308. The control unit 2307 may include an emotion and line-of-sight analysis unit 2307a.

The direction detection unit 2301 includes a nine-axis sensor(s) including a three-axis accelerometer, a three-axis gyroscopic sensor, a three-axis compass sensor, and the like for acquiring the direction of the smartphone (i.e., the orientation of the user).

The position information acquisition unit 2302 includes a GPS (Global Positioning System) receiver, which can detect the current position of the smartphone on the earth and the current time by receiving radio waves transmitted from satellites. Note that position information acquisition unit does not have to be disposed inside the smartphone 0. In that case, the above-described position information acquisition unit 2102 of the hearable device can be used.

The speaker/microphone 2303 may be used by the user to make a phone call (i.e., to talk on the phone). Further, the speaker can be used by the user to listen to the audio content provided from the server.

The display 2304 is composed of a liquid-crystal display and a graphic controller. The display 2304 can display objects such as images and icons, and GUIs. The display 2304 may display a visual content provided from the server.

The camera 2305 includes an image-pickup device such as a CMOS sensor, and can be used to take external video images or still images.

The communication unit 2306 is a communication interface with the network 30. The communication unit 2306 is used to communicate with other network node apparatuses included in the information providing system. The communication unit 2306 may be used to perform radio communication. For example, the communication unit 2306 may be used to perform wireless LAN communication specified in IEEE 802.11 series, or mobile communication specified in 3GPP (3rd Generation Partnership Project) or the like. Further, the communication unit 2306 can also connect to a wearable device or a hearable device through Bluetooth (Registered Trademark) or the like so that they can communicate with each other. The communication unit 2306 can transmit user information (biometric information and line-of-sight information) acquired from the wearable device or the hearable device to the server.

The control unit 2307 is composed of a processor, a memory, and the like, and performs various processes of the smartphone by loading software (a computer program) from the storage unit 2308 onto a memory and executing the loaded software. Further, the control unit 2307 controls hardware included in the smartphone 230. The processor may be, for example, a microprocessor, an MPU (Micro Processing Unit), or a CPU (Central Processing Unit). The processor may include a plurality of processors.

The control unit 2307 may include an emotion and line-of-sight analysis unit 2307 that analyzes the emotion and the line-of-sight of the user based on the biometric information acquired from the wearable device (which is connected to the smartphone so that they can communicate with each other) or based on the orientation of the user acquired from the direction detection unit 2301. The control unit 2307 may identify interest information for the audio content provided from the server based on the biometric information acquired from the wearable device (which is connected to the smartphone so that they can communicate with each other). Further, the control unit 2307 can identify the interest information of the user for the audio content based on the orientation of the user acquired from the direction detection unit 2301.

Note that although a case where the wearable device is used as the biometric information acquisition unit is explained in the above-described example, the present disclosure is not limited to this example. The biometric information acquisition unit may be, for example, a contact-type sensor such as a wristwatch-type sensor (e.g., a smartwatch), or a non-contact-type sensor such as an infrared-type sensor, a radio-wave-type sensor, or a camera that photographs the user.

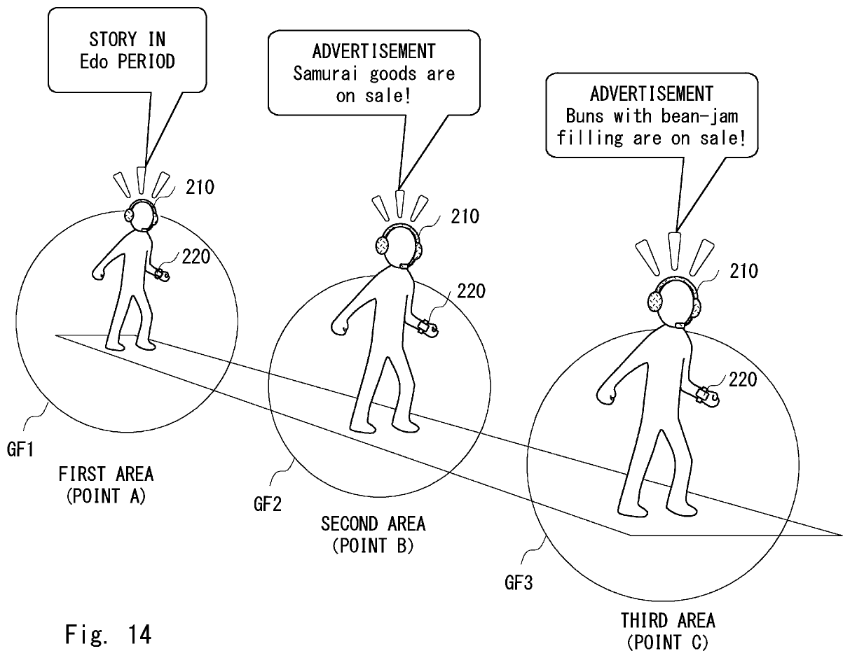

An example of control of a content performed by the server will be described hereinafter with reference to FIGS. 13 and 14.

In a table shown in FIG. 13, a type of content, interest information, an attribute, and details of an audio content are shown for each position. FIG. 14 is a schematic diagram for explaining an outline of control of an audio content service according to the third example embodiment. It is assumed that a route that extends through points A, B and C in this order is defined. When a user reaches the point A, a content for a sightseeing guide of which the attribute is an Edo period is delivered (or distributed) to a user terminal (the hearable device 210 in FIG. 13). It is determined that the user, who has listened to this content, is in an excited state based on biometric information and posture information of the user acquired through the user terminal (the wearable device 220 in FIG. 13).

Next, when the excited state of the user continues (i.e., the user remains in the interested state) at the point B near the point A, an advertisement content having the same attribute (the Edo period in this example) is delivered to the user. For example, an audio content “Samurai goods are on sale!” is delivered as the advertisement content. Note that although the content for a sightseeing guide and the advertisement content have the same attribute in this example, the present disclosure is not limited to this example. For example, when the attribute of the first content is the Edo period, attributes “period”, “old time”, “samurai”, and the like are included in a group of attributes associated with the attribute of the first content. These relevant attributes may be grouped in advance. A first attribute added to the first content information and an attribute group associated with the second content information may be stored in a table or the like in advance.

Further, when the excited state of the user is subsided (i.e., the user is no longer in the interested state) at the point C, an advertisement content 2 having a different attribute is delivered. For example, an audio content “Buns with bean-jam filling are on sale!” is delivered as another advertisement content.

Alternatively, when the user is in a sorrow state at the point B, a different content (e.g., another content for a sightseeing guide) may be delivered.

Although the user has enjoyed the content service by using the hearable device in this example, it is not limited to this example. For example, a smartphone may be used in place of the hearable device. Further, although different content services are controlled in three areas (at three points) in this example, various content services can be controlled in four or more areas.

As shown in FIG. 14, after the first area in which the content is provided, a first advertisement spot may be set, along the route, in a second area (at the point B), and a second advertisement spot may be set, along the route, in a third area (at the point C).

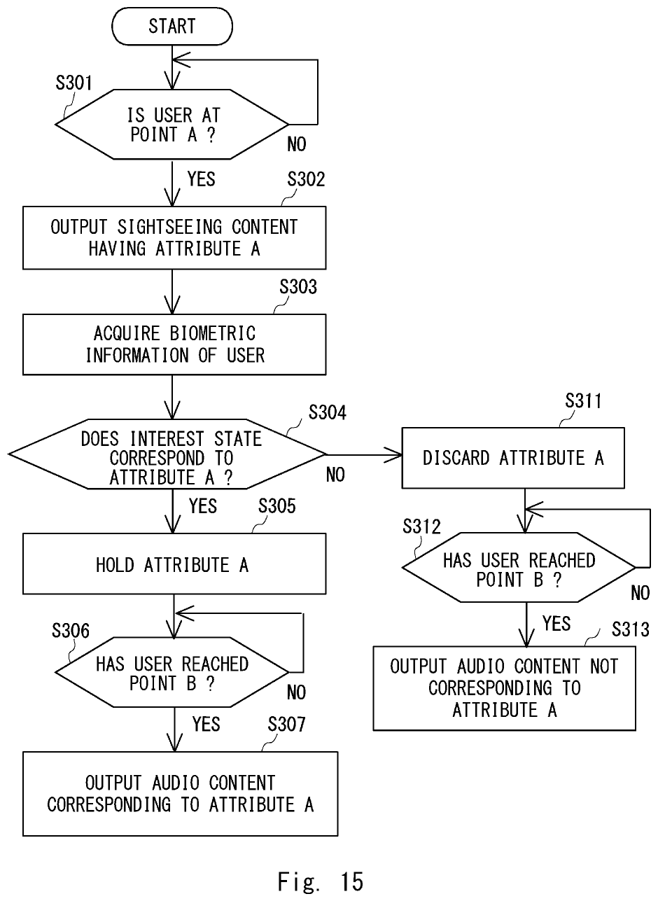

A flow of control of an audio content will be described with reference to FIG. 15.

When the server 10 detects that there is a user terminal 20 at the point A (Yes at Step S301), the server 10 outputs a sightseeing content having an attribute A to the user terminal 20 (Step S302). After that, the server 10 acquires biometric information (and posture information) of the user through user terminal 20 (Step S303). The server 20 analyzes interest information for the content based on the biometric information (and the posture information) of the user.

When the interest information of the user corresponds to the attribute A (Yes at Step S304), the server holds (i.e., retains) the attribute A (Step S305). When the server 10 detects that the user, who possesses the user terminal 20, reaches the point B (Yes at Step S306), the server 10 outputs an audio content corresponding to the attribute A (Step S307).

On the other hand, when the interest information does not correspond to the attribute A (No at Step S304), the server discards the attribute A (Step S311). When the server 10 detects that the user, who possesses the user terminal 20, reaches the point B (Yes at Step S312), the server 10 outputs an audio content that does not correspond to the attribute A (Step S313).

According to the above-described example embodiment, it is possible to analyze the interest of the user in the content based on the biometric information of the user, and thereby to appropriately control the subsequent content based on the analysis.

### Other Example Embodiment

As a modified example of the above-described example embodiment, the present disclosure can also be applied to an advertising fee billing system. When the same advertisement information is provided as the second content to a large number of user terminals (e.g., a large number of hearable devices), the server may calculate the amount of money obtained by multiplying the number of users each of which is properly wearing a user terminal (e.g., a hearable device) by a unit price of the advertisement as an advertising fee. Further, users who are less interested in the content may be excluded from the number of users properly wearing user terminals. In this way, a platform company that manages the server can charge an advertiser(s) an appropriately-calculated advertising fee.

Further, as a modified example of the above-described example embodiment, the present disclosure can also be applied to an advertisement verification system. When advertisement information is provided as a second content to a specific user terminal, the server can also acquire biometric information from this user terminal and analyze the emotion of the user after providing the advertisement information. For example, when the user is frustrated with the advertisement, a platform company managing the server can feed back such a verification result to an advertiser. The advertiser can appropriately modify the advertisement based on such feedback.

In the above-described example, the program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g., magneto-optical disks), CD-ROM (Read Only Memory), CD-R, CD-R/W, DVD (Digital Versatile Disc), BD (Blu-ray (Registered Trademark) Disc), and semiconductor memories (such as mask ROM, PROM (Programmable ROM), EPROM (Erasable PROM), flash ROM, and RAM (Random Access Memory)). Further, the program may be provided to a computer using any type of transitory computer readable media. Examples of transitory computer readable media include electric signals, optical signals, and electromagnetic waves. Transitory computer readable media can provide the program to a computer through a wired communication line (e.g., electric wires, and optical fibers) or a wireless communication line.

Note that the present disclosure is not limited to the above-described example embodiments, and they may be modified as appropriate without departing from the scope and spirit of the disclosure. For example, the user terminal may have some or all of the functions of the server 10. A plurality of examples described above can also be carried out while combining them with one another.

The whole or part of the example embodiments disclosed above can be described as, but not limited to, the following supplementary notes.

### (Supplementary Note 1)

An information providing apparatus comprising:
a storage unit configured to store position information associated with a position on a route, and content information associated with the position information; and
a control unit configured to provide first content information associated with first position information acquired from a user terminal based on the first position information, wherein
the control unit sets an advertisement spot having an attribute associated with an attribute of the first content information provided at a first position at a second position on the route, the second position being a predetermined distance apart from the first position.

### (Supplementary Note 2)

The information providing apparatus described in Supplementary note 1, wherein after the control unit provides the first content information, the control unit analyzes an emotion of at least one user based on biometric information acquired from at least one user terminal, specifies an attribute of the first content information based on a result of the emotional analysis, and sets an advertisement spot having an attribute associated with the specified attribute of the first content information.

### (Supplementary Note 3)

The information providing apparatus described in Supplementary note 2, wherein the user terminal is a wearable device. (Supplementary note 4)

The information providing apparatus described in Supplementary note 1, wherein the control unit analyzes, on the route, a line of sight of at least one user based on line-of-sight information acquired from at least one user terminal, specifies the line of sight of the user at a specific position based on a result of the line-of-sight analysis, and sets an advertisement spot having an attribute associated with the specified line of sight of the user.

(Supplementary note 5)

The information providing apparatus described in Supplementary note 4, wherein the user terminal is a hearable device.

### (Supplementary Note 6)

An information providing system comprising:
a storage unit configured to store position information associated with a position on a route, and content information associated with the position information; and
a control unit configured to provide first content information associated with first position information acquired from a user terminal based on the first position information, wherein
the control unit sets an advertisement spot having an attribute associated with an attribute of the first content information provided at a first position at a second position on the route, the second position being a predetermined distance apart from the first position.

### (Supplementary Note 7)

The information providing system described in Supplementary note 6, wherein after the control unit provides the first content information, the control unit analyzes an emotion of at least one user based on biometric information acquired from at least one user terminal, specifies an attribute of the first content based on a result of the emotional analysis, and sets an advertisement spot having an attribute associated with the specified attribute of the first content.

### (Supplementary Note 8)

The information providing system described in Supplementary note 7, wherein the user terminal is a wearable device.

### (Supplementary Note 9)

The information providing system described in Supplementary note 6, wherein the control unit analyzes, on the route, a line of sight of at least one user based on line-of-sight information acquired from at least one user terminal, specifies the line of sight of the user at a specific position based on a result of the line-of-sight analysis, and sets an advertisement spot having an attribute associated with the specified line of sight of the user.

### (Supplementary Note 10)

The information providing system described in Supplementary note 9, wherein the user terminal is a hearable device.

### (Supplementary Note 11)

An information providing method comprising setting, based on first position information associated with a position on a route, first content information associated with the first position information, and an attribute of the first content information, an advertisement spot information including an attribute associated with the attribute of the first content information and position information indicating a second position on the route, the second position being a predetermined distance apart from the first position.

### (Supplementary Note 12)

The information providing method described in Supplementary note 11, wherein after the first content information is provided, an emotion of at least one user is analyzed based on biometric information acquired from at least one user terminal; an attribute of the first content information is specified based on a result of the emotional analysis; and an advertisement spot having an attribute associated with the specified attribute of the first content information is set.

### (Supplementary Note 13)

The information providing method described in Supplementary note 12, wherein the user terminal is a wearable device.

### (Supplementary Note 14)

The information providing method described in Supplementary note 11, wherein after the first content information is provided, a line-of-sight of at least one user is analyzed based on line-of-sight information acquired from at least one user terminal; the line of sight of the user at a specific position is specified based on a result of the line-of-sight analysis; and an advertisement spot having an attribute associated with the specified line of sight of the user is set.

### (Supplementary Note 15)

The information providing method described in Supplementary note 14, wherein the user terminal is a hearable device.

### (Supplementary Note 16)

A non-transitory computer readable medium storing a program for causing a computer to set, based on first position information associated with a position on a route, first content information associated with the first position information, and an attribute of the first content information, an advertisement spot information including an attribute associated with the attribute of the first content information and position information indicating a second position on the route, the second position being a predetermined distance apart from the first position.

### (Supplementary Note 17)

The non-transitory computer readable medium described in Supplementary note 16, wherein the program further causes the computer to, after providing the first content information, analyze an emotion of at least one user based on biometric information acquired from at least one user terminal, specify an attribute of the first content information based on a result of the emotional analysis, and set an advertisement spot having an attribute associated with the specified attribute of the first content information.

### (Supplementary Note 18)

The non-transitory computer readable medium described in Supplementary note 17, wherein the user terminal is a wearable device.

### (Supplementary Note 19)

The non-transitory computer readable medium described in Supplementary note 16, wherein the program further causes the computer to analyze, on the route, a line-of-sight of at least one user based on line-of-sight information acquired from at least one user terminal, specify the line of sight of the user at a specific position based on a result of the line-of-sight analysis, and set an advertisement spot having an attribute associated with the specified line of sight of the user.

### (Supplementary Note 20)

The non-transitory computer readable medium described in Supplementary note 19, wherein the user terminal is a hearable device.

### REFERENCE SIGNS LIST

1 INFORMATION PROVIDING SYSTEM
8 USER
10 SERVER
20 USER TERMINAL
30 NETWORK
60 Web SERVER
101 CONTROL UNIT
102 STORAGE UNIT
103 ACQUISITION UNIT
210 HEARABLE DEVICE
220 WEARABLE DEVICE
230 SMARTPHONE
1010 ADVERTISEMENT SPOT SETTING UNIT
1011 POSITION INFORMATION ACQUISITION UNIT
1012 EMOTIONAL ANALYSIS UNIT
1013 LINE-OF-SIGHT ANALYSIS UNIT
1014 CONTENT PROVIDING UNIT
1015 ADVERTISEMENT PROVISION CONTROL UNIT
1016 ACOUSTIC LOCALIZATION PROCESSING UNIT
1019 ATTRIBUTE DETERMINATION UNIT
1021 MAP INFORMATION DATABASE
1022 REGISTERED POSITION INFORMATION DATABASE
1023 USER INFORMATION DATABASE
1024 GEOFENCE DATABASE
1025 CONTENT DATABASE
1026 ADVERTISEMENT DATABASE
2101 DIRECTION DETECTION UNIT
2102 POSITION INFORMATION ACQUISITION UNIT
2103 SPEAKER
2104 COMMUNICATION UNIT
2105 CONTROL UNIT
2105a LINE-OF-SIGHT ANALYSIS UNIT
2106 STORAGE UNIT
2201 BIOMETRIC INFORMATION ACQUISITION UNIT
2202 SPEAKER
2203 DISPLAY
2204 COMMUNICATION UNIT
2205 CONTROL UNIT
2205a EMOTIONAL ANALYSIS UNIT
2301 DIRECTION DETECTION UNIT
2302 POSITION INFORMATION ACQUISITION UNIT
2303 SPEAKER/MICROPHONE
2304 DISPLAY
2305 CAMERA
2306 COMMUNICATION UNIT
2307 CONTROL UNIT
2307a EMOTION AND LINE-OF-SIGHT ANALYSIS UNIT
2308 STORAGE UNIT

What is claimed is:

1. An information providing apparatus comprising:
a storage unit configured to store position information associated with a position on a route, and content information associated with the position information; and
at least one memory storing instructions, and
at least one processor configured to execute the instructions to;
provide, when position information acquired from a user terminal is first position information indicating a first position, first content information associated with the first position information,
set an advertisement spot having an attribute associated with an attribute of the first content information provided at the first position at a second position on the route and provides, when the position information acquired from the user terminal is second position information indicating the second position, an advertisement content using the advertisement spot and different from the first content information, the second position being a predetermined distance apart from the first position.

2. The information providing apparatus according to claim 1, wherein the at least one processor configured to execute the instructions to; after providing the first content information, analyze an emotion of at least one user based on biometric information acquired from at least one user terminal, specifies an attribute of the first content information based on a result of the emotional analysis, and sets an advertisement spot having an attribute associated with the specified attribute of the first content information.

3. The information providing apparatus according to claim 2, wherein the user terminal is a wearable device.

4. The information providing apparatus according to claim 1, wherein the at least one processor configured to execute the instructions to; analyze, on the route, a line of sight of at least one user based on line-of-sight information acquired from at least one user terminal, specifies the line of sight of the user at a specific position based on a result of the line-of-sight analysis, and sets an advertisement spot having an attribute associated with the specified line of sight of the user.

5. The information providing apparatus according to claim 4, wherein the user terminal is a hearable device.

6. An information providing system comprising:
a storage unit configured to store position information associated with a position on a route, and content information associated with the position information; and
at least one memory storing instructions, and
at least one processor configured to execute the instructions to; provide, when position information acquired from a user terminal is first position information indicating a first position, first content information associated with the first position information,
set an advertisement spot having an attribute associated with an attribute of the first content information provided at the first position at a second position on the route and provides, when the position information acquired from the user terminal is second position information indicating the second position, an advertisement content using the advertisement spot and different from the first content information, the second position being a predetermined distance apart from the first position.

7. The information providing system according to claim 6, wherein the at least one processor configured to execute the instructions to, after providing the first content information, analyze an emotion of at least one user based on biometric information acquired from at least one user terminal, specifies an attribute of the first content information based on a result of the emotional analysis, and sets an advertisement spot having an attribute associated with the specified attribute of the first content information.

8. The information providing system according to claim 7, wherein the user terminal is a wearable device.

9. The information providing system according to claim 6, wherein the at least one processor configured to execute the instructions to analyze, on the route, a line of sight of at least one user based on line-of-sight information acquired from at least one user terminal, specifies the line of sight of the user at a specific position based on a result of the line-of-sight analysis, and sets an advertisement spot having an attribute associated with the specified line of sight of the user.

10. The information providing system according to claim 9, wherein the user terminal is a hearable device.

11. An information providing method comprising setting, based on first position information indicating a first position associated with a position on a route, first content information associated with the first position information, and an attribute of the first content information, an advertisement spot information including an attribute associated with the attribute of the first content information and position information indicating a second position on the route, and providing, when position information acquired from a user terminal is second position information indicating the second position, an advertisement content using the advertisement spot and different from the first content information, the second position being a predetermined distance apart from the first position.

12. The information providing method according to claim 11, wherein after the first content information is provided, an emotion of at least one user is analyzed based on biometric information acquired from at least one user terminal; an attribute of the first content information is specified based on a result of the emotional analysis; and an advertisement spot having an attribute associated with the specified attribute of the first content information is set.

13. The information providing method according to claim 12, wherein the user terminal is a wearable device.

14. The information providing method according to claim 11, wherein after the first content information is provided, a line-of-sight of at least one user is analyzed based on line-of-sight information acquired from at least one user terminal; the line of sight of the user at a specific position is specified based on a result of the line-of-sight analysis; and an advertisement spot having an attribute associated with the specified line of sight of the user is set.

15. The information providing method according to claim 14, wherein the user terminal is a hearable device.

16-20. (canceled)
